(19) United States
(12) Patent Application Publication
(10) Pub. No.: US 2026/0226830 A1
(43) Pub. Date: Aug. 6, 2026

(54) APPARATUS, SYSTEM AND METHOD FOR USE WITH UTILITY TUNNELS

(71) Applicant: British Telecommunications Public Limited Company, London Greater London (GB)

(72) Inventors: Daniel GILKS, London Greater London (GB); Violeta NOVAKOVIC, London Greater London (GB); Malcolm HUBERT, London Greater London (GB)

(21) Appl. No.: 19/147,945

(22) PCT Filed: Dec. 12, 2023
(86) PCT No.: PCT/EP2023/085331

§ 371 Date: Jul. 14, 2025

(30) Foreign Application Priority Data
Jan. 19, 2023 (EP) 23152386.1

(51) Int. Cl. E21D 5/11

(52) U.S. Cl. CPC E21D 5/11

(57) ABSTRACT

An apparatus for lining for a borehole (105), said apparatus comprising a/an: eversible structure (115) configured to be everted into a distended structure (400) defining a lumen (410) and to grow apically; cavity provided within the eversible structure and arranged to surround the lumen; and curable material (150), provided within the cavity, for setting into a solid under a curing action, thereby to form a solid structure (440).

### FIELD OF INVENTION

The present invention relates to an apparatus, system and method for use with utility tunnels, and in particular incorporating an eversion robot for internally lining such tunnels.

### BACKGROUND

Utilities infrastructure (e.g. water, gas, sewage, logistics, telecommunications and power) often use utility tunnels (or “ducts”, “tubes” or “pipes”) through which to route infrastructure. However, installation and maintenance of such tunnels is resource-intensive. For example, installation of a tunnel may require excavation along the entire route of the tunnel (which may be kilometres long), and then making good the excavated works; this may require heavy and complex machinery, specialised labour, permits, and road closures.

To help negate the need for excavation, boring may instead be used to form a tunnel from a borehole, which is then lined so as to form a utility tunnel. However, boring may again require specialised labour, as well as heavy and complex machinery, and lining non-linear boreholes is particularly difficult, especially for smaller-diameter boreholes, such as for utilities.

It is an aim of the present invention to at least alleviate some of the aforementioned problems.

### STATEMENTS OF INVENTION

According to a first aspect of the present invention, there is provided: an apparatus for lining for a borehole, said apparatus comprising a/an: eversible structure configured to be everted into a distended structure defining a lumen and to grow apically; cavity provided within the eversible structure and arranged to surround the lumen; and curable material, provided within the cavity, for setting into a solid under a curing action, thereby to form a solid structure.

Preferably, the eversible structure is formed of a double-walled membrane, and wherein the cavity is defined by the double-walled membrane. Preferably, the double-walled membrane encases the cavity. Optionally, each wall of the double-walled membrane is coupled together using a coupling, in which the coupling may be a/an: coupling member; stitch; brace; post; wall; tether; rivet; and/or an adhesive. Optionally, the eversible structure comprises a single membrane forming the cavity, which may be folded back upon itself to form a double wall. Optionally, the eversible structure comprises a plurality of pockets or a plurality of cavities, said plurality together forming the cavity. Optionally, the eversible structure comprises a cellular arrangement of the plurality of cavities, in which each of the plurality of cavities may be entirely or partially sealed-off from one another.

Preferably, the cavity is entirely enclosed by the eversible structure, thereby sealing the curable material within the eversible structure. Alternatively, the double-walled membrane may be sealed at only one end of the eversible structure, thereby providing a bag-like structure, defining the cavity as an open chamber. Preferably, the eversible structure is impermeable to, at least, the curable material, thereby to prevent escape of said material from within the eversible structure.

Preferably, the eversible structure further comprises an opening arranged at a terminal end of the eversible structure, for receiving a fluid for forcing eversion of the eversible structure. Preferably, the opening comprises a fastening formation for fixedly fastening the opening to an engagement formation. Optionally, the fastening formation is a clamp; bracket; friction or bayonet fitment; tether; elasticated formation. Optionally, the engagement formation is a fluid output of a pump for pumping a fluid into the opening thereby to evert the eversible structure. Optionally, the fastening formation comprises a seal for forming a fluid-tight seal with the fluid output.

Preferably, the eversible structure comprises a valve for connecting the lumen with an exterior of the eversible structure, said valve being configured to permit escape of fluid from the lumen. Preferably, the valve is arranged at an end of the eversible structure, in which said end may be the terminal end or may be arranged distally to said terminal end. Preferably, the valve is a gas valve, and may be a bleed or overpressure valve.

Preferably, the eversible structure, distended structure, and/or the solid structure is/are formed as a tubular, spheroid or planar structure. Optionally, the eversible structure, distended structure, and/or the solid structure is/are formed as an elongate structure. Preferably, the eversible structure is substantially flat prior to being everted.

Preferably, the eversible structure is formed into a coil. Preferably, the apparatus further comprises a spool or a drum, and wherein the eversible structure is coiled about said spool or drum.

Preferably, the apparatus further comprises a tether coupled to the eversible structure so as to pull the tether as the eversible structure grows apically. Preferably, the tether is coupled, or proximate, to the end of the eversible structure. Preferably, the tether is a drawstring for pulling a cable.

Preferably, the eversible structure is dimensioned to be received within a borehole when formed into the distended structure. Preferably, the eversible structure is dimensioned to abut against an internal wall of the borehole when formed into the distended structure. Preferably, the eversible structure, distended structure and/or solid structure has/have a width or diameter of between 2.5 cm to 1 m, more preferably between 5 cm and 50 cm, still more preferably between 10 cm and 30 cm. Preferably, the eversible structure, distended structure and/or solid structure is/are dimensioned so as to span, at least, through the entirety of the borehole. Preferably, the eversible structure, distended structure and/or solid structure has/have a length of between 2.5 m and 1 km, more preferably between 5 m and 250 m, still more preferably between 10 m and 100 m.

Preferably, the curable material comprises a curable resin. Preferably, the curable resin comprises a/an: epoxy resin; polyester resin; and/or vinyl ester. Optionally, the curable resin comprises: Supreme 3HT-80, UV22DC80-1, Med EP4UF-80, and/or EP5G-80, each as supplied by Master Bond Inc. of 154 Hobart St, Hackensack, NJ 07601, United States. Optionally, the curable material (also) comprises cement, plaster and/or clay.

Preferably, the curing action is: heating; light exposure; and/or exposure to a curing additive. Optionally, the heating is performed to achieve a temperature of between 50° C. and 200° C., more preferably 70° C. and 150° C., and still more preferably between 80° C. and 100° C. Optionally, the light is in the visible, ultraviolet, microwave and/or infrared spectrum. Optionally, the curing additive is a hardener and/or water.

Preferably, the apparatus further comprises a curing apparatus for causing the curing action.

Preferably, the apparatus further comprises a non-excavating drill, wherein the drill is arranged to be urged by apical growth of the eversible structure. Optionally, the drill is arranged at an eversion front of the eversible structure, and may be in direct contact with the eversible structure or coupled via a socket, which may have a concave form so as to aid eversion. Preferably, the non-excavating drill is a compressive or percussive drill. Preferably, the non-excavating drill comprises the socket, arranged at a rear (i.e. away from a drilling front) of said drill, for receiving the eversion front of the eversible structure. Preferably, the drill is uncoupled, unfastened and/or unfixed from the eversible structure. Optionally, the apparatus further comprises a tether for coupling the non-excavating drill to the eversible structure. Preferably, the apparatus further comprises an electric cable, extending through the distended structure (and specifically within the lumen) and for connecting the non-excavating drill to a power source, thereby to transmit power from said source to said drill.

According to another aspect of the invention, there is provided a system for forming a supporting lining for a borehole, said system comprising: an apparatus comprising a/an: eversible structure configured to be everted into a distended structure defining a lumen and to grow apically; cavity provided within the eversible structure and arranged to surround the lumen; and curable material, provided within the cavity, for setting into a solid under a curing action, thereby to form a solid structure; a pump for pumping a fluid at the eversible structure so as to cause eversion and apical growth of the eversible structure; and a curing apparatus for causing the curing action thereby to set the curable material into a solid. Preferably, the pump is a gas pump and the fluid is air.

Optionally, the pump is a liquid pump and the fluid is water. Optionally, the cavity is open-ended, wherein the pump is configured to connect with the cavity so as to pump the curable material into the cavity so as simultaneously to force eversion of the eversible structure and inject the curable material into the cavity.

Preferably, the system further comprising a sealed pressure vessel containing the pump and the apparatus, wherein the sealed pressure vessel comprises an engagement formation for engaging the apparatus, and wherein the eversible structure is configured to evert and apically grow away from the pressure vessel under pressure from within the pressure vessel. Optionally, the system further comprises a (or the aforementioned) drill, arranged to interface with the eversible structure (directly or via a socket) so as to be pushed by the eversible structure.

According to yet another aspect of the invention, there is provided a method of operating a system for lining a borehole, wherein the method comprises the steps of: fixing an everted end of an apparatus as described above; operating a pump so as to pump a fluid at the eversible structure thereby to force eversion and apical growth of the eversible structure away from the everted end and into the distended structure; performing a curing action, using a curing apparatus, thereby to set the curable material and the eversible structure into the solid structure.

Preferably, the curing action is performed whilst also operating the pump so as to pump a fluid at the eversible structure. Preferably, the method further comprises the step of cutting an end of the eversible structure after having formed the solid structure, thereby to expose the lumen.

According to still a further aspect of the inventio, there is provided a computer-readable carrier medium comprising a computer program, which, when the computer program is executed by a computer, causes the computer to carry out at least some of the steps of any the aforementioned method.

As used herein, the term “eversible structure” and/or “eversion robot” preferably refers to an apparatus or mechanical system having at least some of the following characteristics: eversion of an enclosing membrane; a growing or extendable mechanism or robot; a pressure-driven and/or fluid-driven mechanism; a soft growing mechanism or robot; a tubular or vine growing mechanism or robot; and/or a mechanism or robot exploiting apical growth.

Optionally, the apparatus is configured to be manipulated so as to be operated as a steerable soft growing or eversion robot. Optionally, the membrane is formed of a thermally conductive material. Optionally, the membrane is formed of a material that is transparent to light, and in particular to a wavelength of light used for the curing action. Preferably, the membrane is: compliant; soft; malleable; elastic or inelastic; impermeable, semi-permeable or permeable to liquid (and in particular the curable material and/or water) and/or gas. Optionally, the membrane is formed of a material comprising: plastic; rubber; a composite material; a woven material; and/or a fabric. Preferably, the eversible structure is capable of inversion into itself. Preferably, the solid structure is a duct, pipe, conduit or tunnel. Preferably, the eversible structure is configured to grow apically in the direction of eversion.

Preferably, the curable material is free-flowing, compliant and/or malleable. Preferably, the curable material has a viscosity of less than 10,000 mPa·s, more preferably less than 2,000 mPa·s, still more preferably less than 100 mPa·s, and yet more preferably less than 50 mPa·s. Preferably, the curable material is configured to cure into a rigid solid structure, and more preferably into a single integral solid structure. Preferably, the curable material comprises a fluid (liquid and/or gas) and/or particulate solid. Optionally, the curing apparatus is connected to the lumen and/or cavity, thereby to permit fluid exchange therebetween, in which the fluid may be air, water or the curable material. Optionally, the curing apparatus comprises a pump for pumping a fluid into the lumen and/or cavity. Optionally, the curing apparatus comprises a heater. Optionally, the curing apparatus comprises an electrical resistance wire heater. Optionally, said wire is embedded within the eversible structure and/or cavity. Optionally, the curing apparatus comprises a light source. Optionally, the light source is provided within receivable within the lumen and/or cavity, and may be a strip light or a light wand.

Optionally, the cavity further comprises a reinforcing medium dispersed within the curable medium and for mechanically reinforcing the rigid solid. Optionally, the reinforcing medium comprises a flexible wire or mesh, aggregate, particulate, and/or fibres. Preferably, the cavity completely, partially or intermittently surrounds the lumen, longitudinally, laterally, and/or radially.

The invention includes any novel aspects described and/or illustrated herein. The invention also extends to methods and/or apparatus substantially as herein described and/or as illustrated with reference to the accompanying drawings. The invention is also provided as a computer program and/or a computer program product for carrying out any of the methods described herein and/or for embodying any of the apparatus features described herein, and a computer-readable medium storing thereon a program for carrying out any of the methods and/or for embodying any of the apparatus features described herein. Features described as being implemented in hardware may alternatively be implemented in software, and vice versa.

Any apparatus feature may also be provided as a corresponding step of a method, and vice versa. As used herein, means plus function features may alternatively be expressed in terms of their corresponding structure, for example as a suitably-programmed processor.

Any feature in one aspect of the invention may be applied, in any appropriate combination, to other aspects of the invention. Any, some and/or all features in one aspect can be applied to any, some and/or all features in any other aspect, in any appropriate combination. Particular combinations of the various features described and defined in any aspects of the invention can be implemented and/or supplied and/or used independently.

As used throughout, the word ‘or’ can be interpreted in the exclusive and/or inclusive sense, unless otherwise specified.

The invention extends to an apparatus, a system, and a method as described herein and/or substantially as illustrated with reference to the accompanying drawings. The present invention is now described, purely by way of example, with reference to the accompanying diagrammatic drawings, in which:

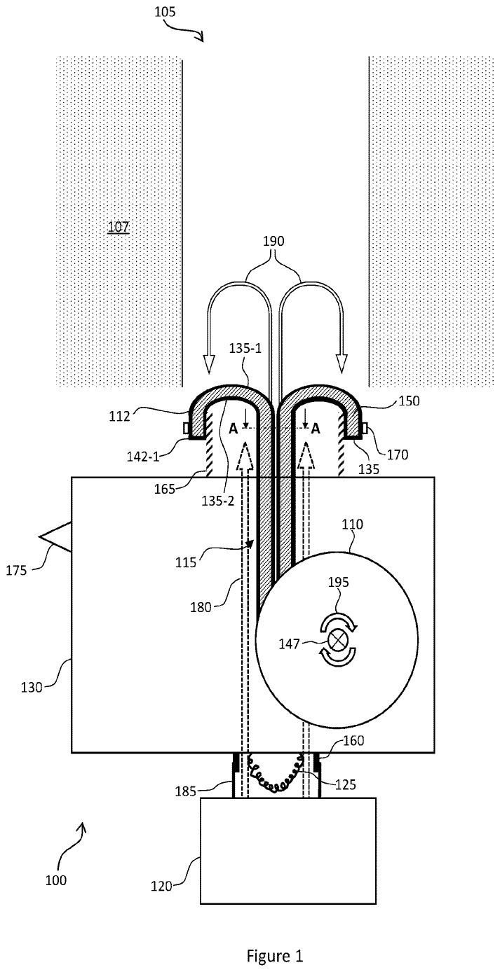

FIG. 1 shows an exemplary system for lining a borehole using an eversion robot;

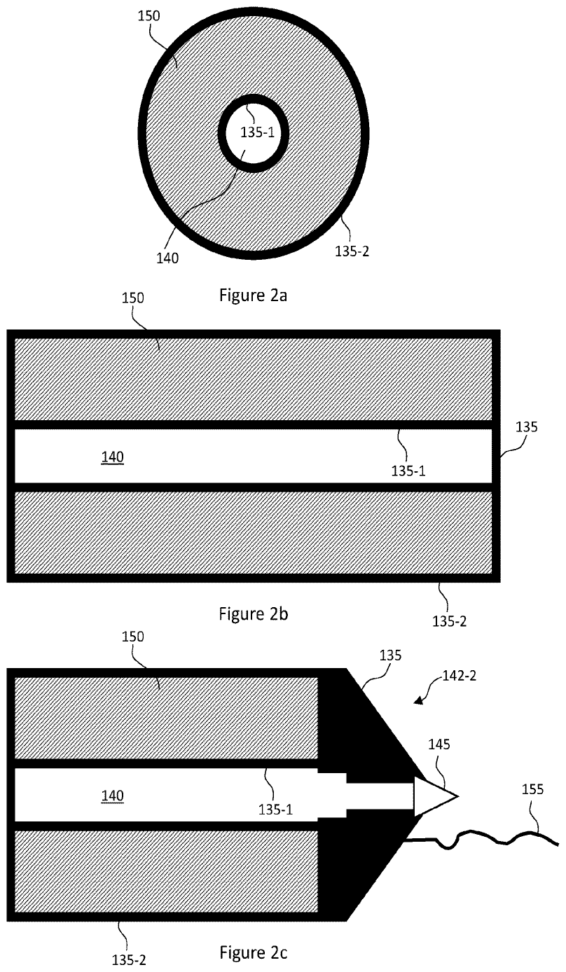

FIGS. 2a, 2b and 2c show details of the eversion robot;

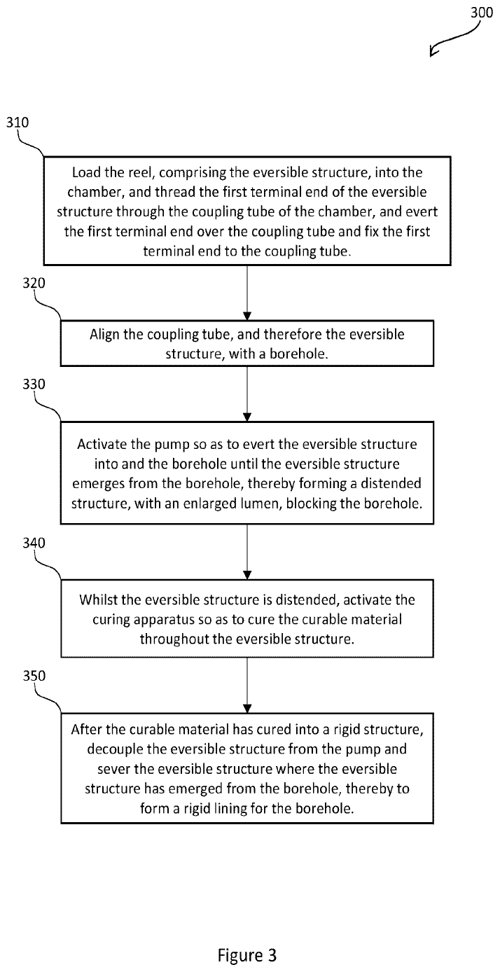

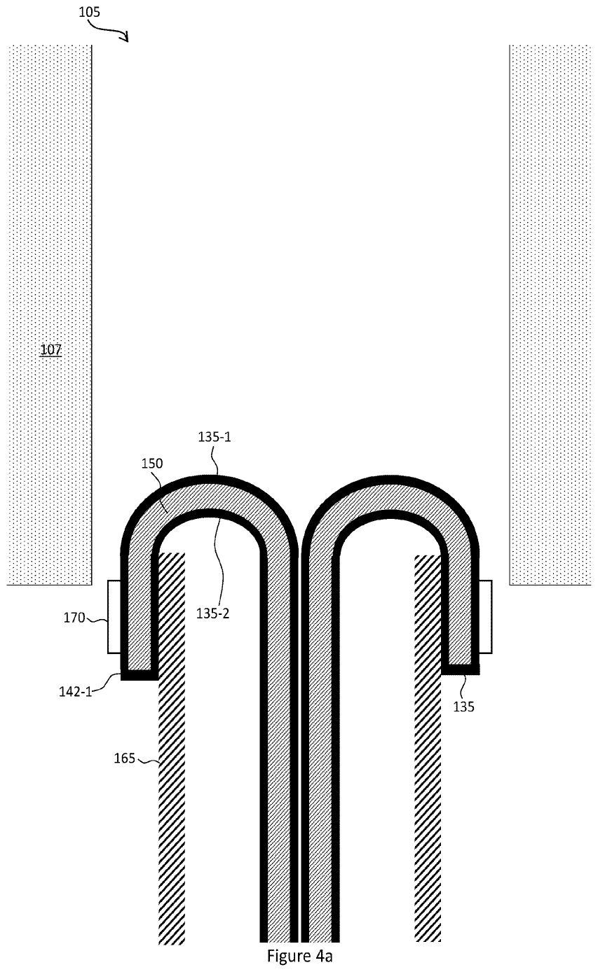

FIG. 3 is a process for operating the system;

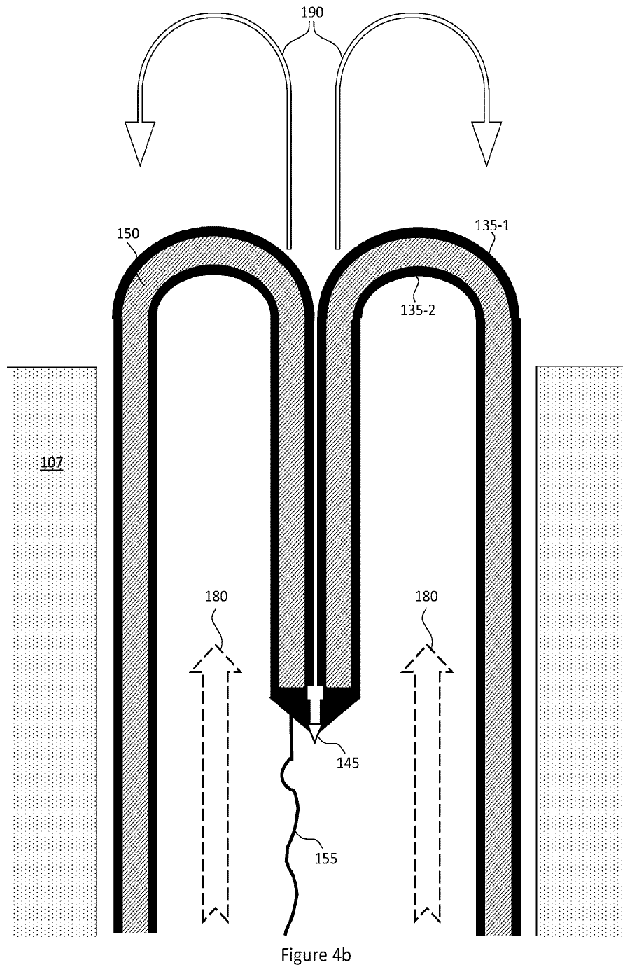

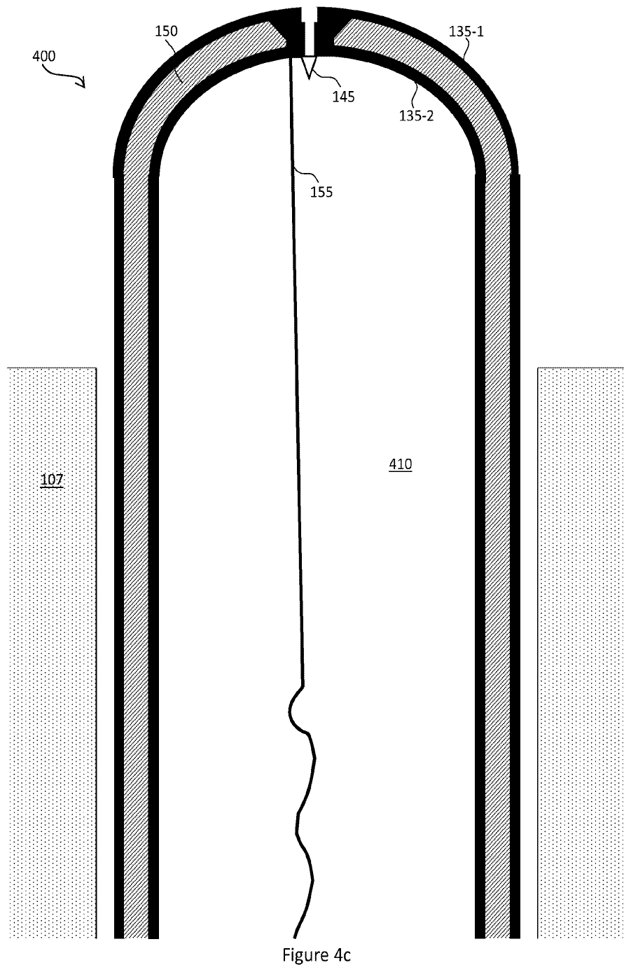

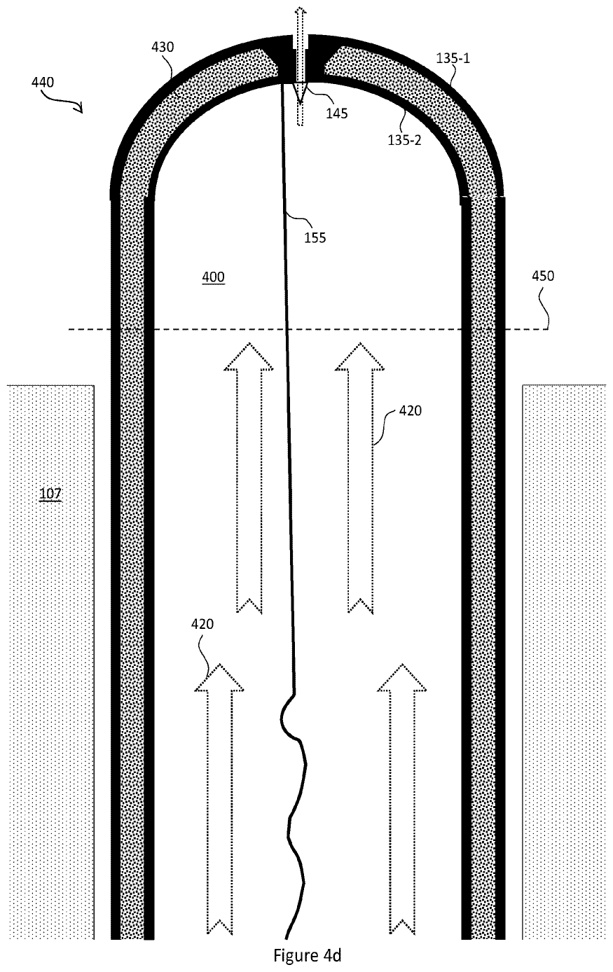

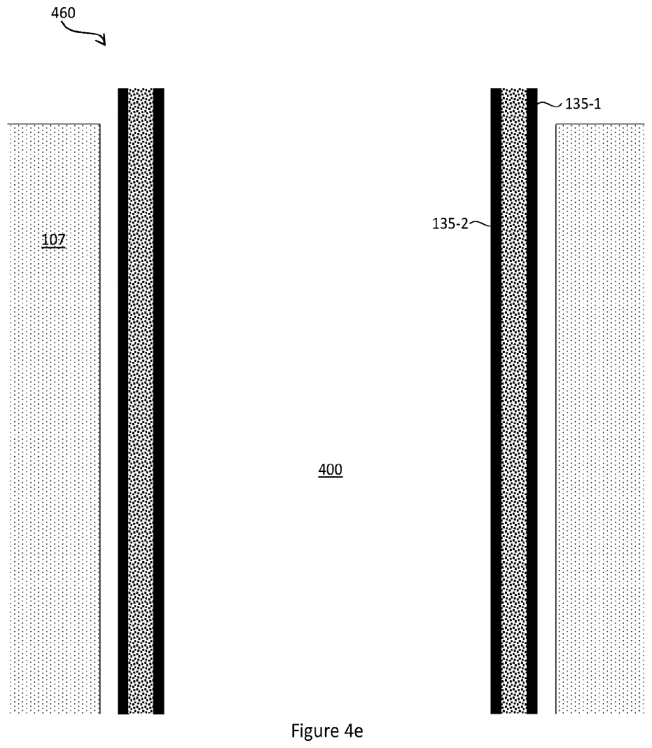

FIGS. 4a, 4b, 4c, 4d and 4e show details of the eversion robot in use;

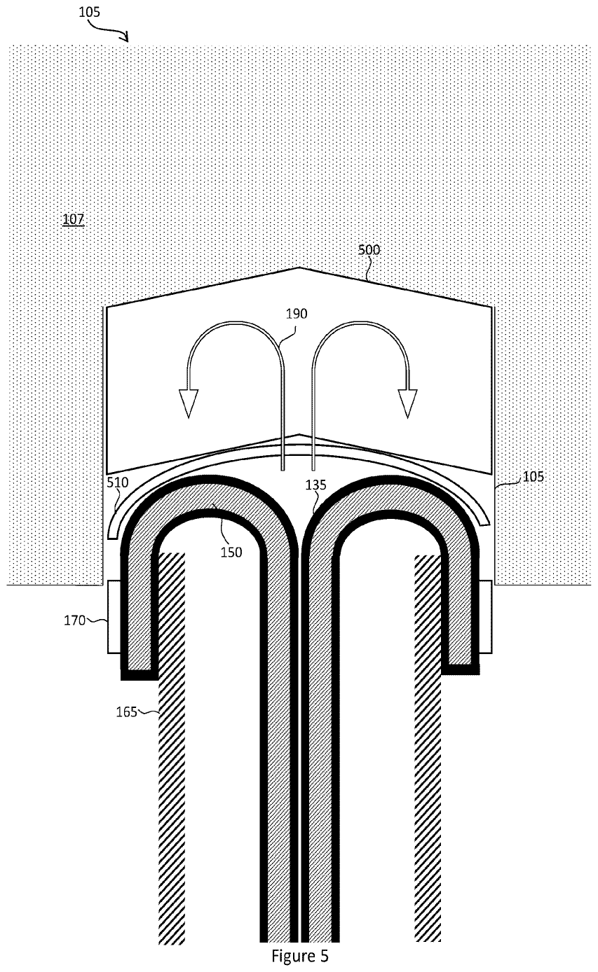

FIG. 5 shows the eversion robot with a drill; and

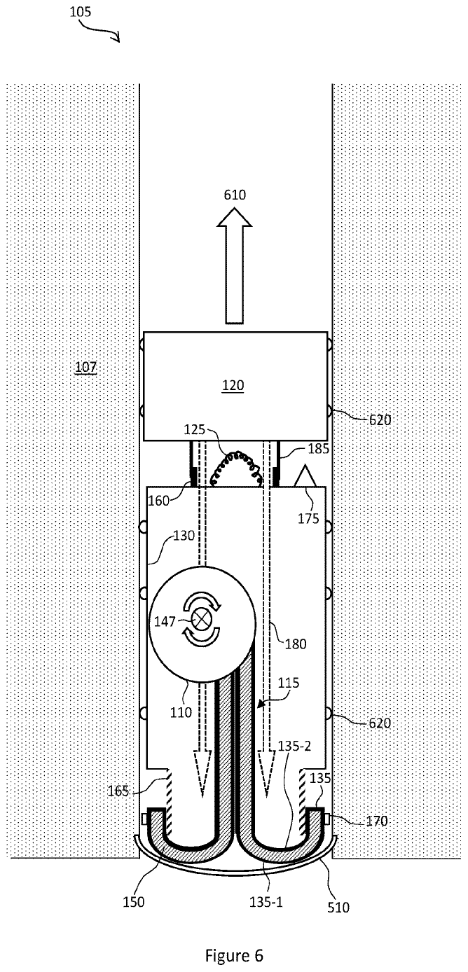

FIG. 6 shows an exemplary alternative arrangement of the system.

### SPECIFIC DESCRIPTION

FIG. 1 is a schematic diagram of a system 100 for forming a rigid supporting lining for a borehole 105 through a substrate 107 (e.g. earth), thereby to provide a tunnel for routing utility infrastructure (e.g. cables for telecommunications and/or power cables, and/or pipes or tubes for water, refuse, sewage, gas and/or logistics, such as pneumatic tube transport systems).

Specifically, the system 100 is in the form of an eversion robot (or a soft growing robot) that comprises a/an: reel 110 of an eversible structure 115; pump 120; curing apparatus 125; and chamber 130.

The eversible structure 115 is now described in more detail with reference to schematic FIG. 2, in which FIG. 2a shows a lateral cross-section through the eversible structure 115 along the plane A-A, as represented in FIG. 1, and FIG. 2b shows a longitudinal cross-section along a plane perpendicular to plane A-A.

The eversible structure 115 comprises a membrane 135 that is configured to enclose an internal cavity and that is formed into an elongate tubular structure presenting an inner wall 135-1, an outer wall 135-2 and a lumen 140. The eversible structure 115 comprises a first terminal end 142-1 having an opening such that the lumen is accessible, and also comprises a distal second terminal end 142-2. In a non-everted state, as shown in FIG. 2, the inner wall 135-1 directly faces and defines the lumen 140, whereas the outer wall 135-2 is outward-facing.

The internal cavity is provided entirely within the membrane 135, and is defined, at least, by a double-wall structure formed by the inner wall 135-1 and the outer wall 135-2. In the example of FIGS. 1 and 2, the internal cavity is entirely sealed by the membrane. The internal cavity is filled with a curable material 150, which is therefore contained and sealed within the membrane 135.

The curable material 150 consists of free-flowing matter that, under a curing action, solidifies into a single rigid solid structure. In particular, the curable material comprises a liquid, gas, and/or fine particulate. For example, the curable material comprises, or consists of, a liquid resin (e.g. epoxy, polyester and/or vinyl ester) or cement. Correspondingly, the curing action is available to be: addition of a curing substance, such as a hardener; heating; and/or exposure to light (e.g. UV). In the example of the figures, the curing action is heating to at least a curing temperature.

The eversible structure 115 is constructed so as to be everted 190, such that the inner wall 135-1 can be made to surround the outer wall 135-2 and for the inner wall 135-1 to become outward-facing instead. To do so, the eversible structure formed of a material that is flexible and compliant. The eversible structure is also dimensioned also to permit eversion by providing a relatively thin membrane (from the inner wall 135-1 to the outer wall 135-2) relative to the dimensions of the lumen 140; that is, if the former is too thick relative to the latter, then the eversible structure may not be eversible, or may require too significant a force to cause eversion.

The eversible structure 115 is wound around the reel 110 so as to form a coil of the eversible structure. In this way, the eversible structure is dispensable from the reel 110, which is coupled to a spindle 147 about which the reel is free to rotate.

FIG. 2c is a lateral cross-section through the eversible structure 115 corresponding to that of FIG. 2b but instead at the second terminal end 142-2. At the second terminal end 142-2, the lumen 140 is sealed by the membrane and a bleed valve 145 for regulating the escape of fluid (particularly gas) from the lumen. At the second terminal end 142-2, a drawstring 155 is also fastened to the membrane, and specifically to the outer wall 135-2.

The chamber 130 is a pressure vessel, comprising an input port 160 that is configured to engage with the pump 120 for fluid exchange therefrom.

The chamber 130 further comprises a coupling tube 165 dimensioned to be received by the eversible structure 115 by everting 190 the first terminal end 142-1 over and onto the coupling tube 165, as shown in FIG. 1. To help retain the everted eversible structure 115 engaged to the coupling tube, there is provided an engagement formation 170 for fixedly engaging the eversible structure 115. For example, the engagement formation 170 is in the form of a clamp, and specifically a band clamp. The coupling tube 165 and input port 160 are in fluid communication, thereby to permit flow of fluid therebetween.

The chamber 130 further comprises an escape valve 175 for exhausting gas from within the chamber, thereby to reduce pressure within the chamber (relative to atmospheric pressure). An inside of the chamber is accessible to a user so as to load the reel 110 onto the spindle 147.

In this example, the pump 120 is an air pump configured to generate a flow of air 180 and compress air into the chamber 130. The pump comprises an exhaust vent 185, through which the flow of air is directed. The exhaust vent is configured hermetically to mate with the input port 160, thereby to direct the flow of air 180 into the chamber 130. In this way, the pump is capable of building up fluid pressure within the chamber 130 when the chamber is sealed.

The curing apparatus 125 performs the curing action, thereby to cause, or accelerate, curing of the curable material 150 inside the internal cavity. Accordingly, in this example, the curing apparatus 125 is a heater, such as a wire resistance heater arranged within the exhaust vent 185.

As described in more detail below, the system 100 is operated so as to evert 190 and distend the eversible structure 115 through the borehole 105, and then to form, from the curable material, a rigid internal lining for the borehole; FIG. 3 shows a process 300 for operating the system 100 in this way, which is described with reference to FIGS. 4a to 4e, which in turn schematically show the state of the eversible structure 115 at various stages of the process 300.

At a first step 310, the system 100 is prepared by loading the reel 110, around which the eversible structure 115 is wound, onto the spindle 147. The eversible structure 115 is then dispensed from the reel 110 and threaded out of the chamber 130 and through the coupling tube 165. The first terminal end 142-1 of the eversible structure is then everted 190 and fitted back over the coupling tube 165. The eversible structure is then hermetically fasted to the coupling tube 165 using the engagement formation 170, and the chamber 130 is sealed.

At a next step 320, and as best shown in FIG. 4a, the coupling tube 165 is aligned with, and partially arranged within, an opening of the borehole 105. At this stage, the coupling tube 165 presents an eversion front 190 of the eversible structure towards the inside of the borehole.

At a next step 330, the pump 120 is activated so as to generate the flow of air 180 into the chamber 130. Since the chamber is sealed, the chamber is therefore pressurised. The increased pressure within the chamber urges (or pushes) against the everted outer wall 135-2 proximate to the coupling tube 165, which forces the eversible structure 115 to evert 190. In this way, the eversible structure grows apically (i.e. “from the tip”) into the borehole, away from the coupling tube 165, moving the eversion front of the eversible structure deeper into the borehole. By this everting action 190 and by the effect of inflation, the eversible structure also distends towards the walls of the borehole 105, thereby filling-out the borehole. The growth of the eversible structure draws, by unwinding 195, more of the eversible structure from the reel 110, thereby feeding further eversion.

The pump 120 continues to be operated so that the eversible structure 115 emerges from another end of the borehole, as shown in FIG. 4b. Because of the nature of soft growing robots (such as eversion robots), the path between the openings of the borehole in FIGS. 4a and 4b can be non-linear, even labyrinthine, and still be navigable by the eversible structure.

In the example of FIG. 4c, the eversible structure 115 continues to be everted until the second terminal end 142-2 also emerges from the borehole 105, and therefore until no more of the eversible structure remains to feed eversion. In an alternative, to prevent further apical growth of the eversible structure, the reel 110 is fixed (e.g. using a braking mechanism or by anchoring the drawstring 155) thereby to prevent further unwinding 195 and dispensing of the eversible structure 115 once the eversible structure emerges from the borehole.

In any event, continued operation of the pump 120, without further apical growth, causes the everted eversible structure to take a fully distended form 400, as shown in FIG. 4c, in which the eversible structure reaches a maximum gauge (as limited by the membrane 140 and/or by the borehole dimensions). However, to help form a snug internal lining for the borehole 105, an outer diameter of the fully distended form 400 is dimensioned substantially to match the internal diameter of the borehole. In this fully distended form 400, the external wall 135-2 defines an enlarged lumen 410 that is to serve as a new passage through the borehole.

At a next step 340, once the eversible structure 115 has been fully distended, as in the example of FIG. 4c, the curing apparatus 125 is operated so as to interact with, and help cause curing of, the curable material 150.

In this example, the curing apparatus 125, in the form of a heater, is activated so as to heat air within the chamber 130; at the same time, the pump 120 is operated to move heated air 420 into the enlarged lumen 410, and therefore to heat the curable material 150, whilst also serving to maintain the fully distended form 400. To help prevent over-pressuring of the eversible structure 115, the bleed valve 145 permits air to escape from within the enlarged lumen 410, as shown in FIG. 4d. The bleed valve also helps allow cool air to be displaced by the heated air 420 (aided, in particular, by arranging the bleed valve at the second terminal end 142-2, distally to the heater).

Once curing is complete such that the curable material 150 has solidified into a solid structure 430, the curing apparatus 125 and the pump 120 are deactivated. The solid structure 430 therefore forms the eversible structure 115 into a self-supporting rigid structure 440 that mimics the shape of the fully distended form 400, as shown in FIG. 4d.

At this point, the rigid structure 440 is still sealed by the chamber 130 and by the second terminal end 142-2, therefore blocking the borehole 105. Accordingly, at a next step 350, the rigid structure 440 is severed 450 (e.g. by cutting through the rigid structure 440 and decoupling the first terminal end 142-1 from the coupling tube 165) proximate the openings of the borehole, thereby forming a rigid tube 450 lining the borehole and providing the-now exposed-enlarged lumen 410 as a new passage through the borehole, as shown in FIG. 4e. Accordingly, the rigid tube 450 can now be used as a utility tunnel.

### Alternatives and Modifications

In FIGS. 1 and 4, the borehole 105 is available either to be lined (e.g. by having a tube, pipe or duct already installed through the borehole) or unlined (i.e. a passage through the exposed substrate 107). Accordingly, the system 100 is available to be used to line or re-line (as in the case of repair work) a borehole 105 for use as a utility tunnel.

In the description above, the system 100 is generally described as being hermetically sealed (in particular, the chamber 130 and the interface between the eversible structure 115 and the coupling tube 165). However, it will be appreciated that a sufficient and sustained force against the everted outer wall 135-2 is suitable to cause continued eversion 190. Accordingly, in an alternative, albeit at the expense of efficiency, the system 100 need not be hermetically sealed, and instead, for example, a strong air jet is used to provide an everting force.

In yet another alternative, a liquid is used to evert the eversible structure. In this case, the pump is a liquid pump, such as for pumping water. This alternative may be particularly advantageous where the borehole 105 may be liable to collapse, and where the eversible structure 115, pump 120 and/or the chamber 130 would otherwise be unable to hold a pressure that supports the borehole were a gas to be used.

As will be appreciated, the curing apparatus is any apparatus suitable for curing the curable material 150. In an alternative, where the curing action for the curable material is irradiation with light (e.g. UV), the curing apparatus is a light configured to illuminate the curable material when the eversible structure is in the fully distended form 400. For example, the light is provided at an end of an extendable wand or duct rod for insertion into the enlarged lumen 410. Where the curing action is light, at least, the outer wall 135-2 is formed of a material that is transparent to the wavelength of light required for curing. In yet another example, the curing action is mixing of a hardener with the curable material 150, for example by using a reservoir containing the hardener and a further pump configured to introduce the hardener into the internal cavity of the eversible structure 115.

In an alternative, the internal cavity within which the curable material 150 is provided is formed of a series of pockets, which are available to be interconnected or entirely sealed-off from one another. For example, the pockets are defined by the inner and outer walls 135, along with a connecting stich, rivet, pillar, post or interstitial wall. Advantageously, by forming the internal cavity into entirely segregated pockets, the curable material (which is free-flowing, so as not to impede eversion) is containable to a greater degree in the event of a puncture to the membrane 135.

In yet another example, the eversible structure 115 is provided on the reel 110 without the curable material 150, and therefore with the internal cavity empty. Instead, the curable material is pumped into the internal cavity as the eversible structure is dispensed from the reel. To do so, a reservoir of the curable material is provided that feeds a, or the 120, pump, along with a feed tube connecting said pump with the internal cavity, such as at or proximate the first terminal end 135-1. Advantageously, in this alternative, pumping of the curable material into the cavity is available solely to cause, or at least to aid, eversion of the eversible structure 115.

In FIGS. 1 to 4, the system 100 is operated so as to line (or re-line) an already-completed borehole 105. In an alternative, as shown in, and described with reference to, FIG. 5, the apical growth produced by the eversible structure is synergistically used also to urge a drill 500 through the substrate 107 so as simultaneously to form and line the borehole 105. To do so, the drill 500 is recessed into the substrate 107, and positioned ahead of the eversion front of the everting structure 115. To help deliver forward movement, without excessively impeding eversion, a concave socket 510 is positioned between the eversion front and the drill 500. The concave form of the socket 510 allows the everting structure to evert and grow, which in turn urges the concave socket 510 against the drill, and in turn pushes the drill 500 forwards into the substrate 107. Since the everting structure 115 effectively blocks the forming borehole 105 when distended, a path for removing spoilage is obstructed. Accordingly, in this example, the drill 500 is in the form of a non-excavating drill, such as a compressive, reciprocating or percussive drill, that is instead configured to shift material forwards and/or outwards, rather than backwards (i.e. towards the everting structure 115).

In a further alternative, orientation of the system 100 is reversed so that the entire system is propelled through the borehole 105 by apical growth of the everting structure 115, as exemplarily represented in FIG. 6. To do so, the system 100 is dimensioned so as entirely to be received by the borehole 105, within which the system 100 is then arranged. The everted first terminal end 142-1 is orientated to face away from the intended forward direction of the system through the borehole. A solid structure against which the eversion front of the eversible structure 115 can push is provided and fixed relative to the system 100; this solid structure is available to correspond with the concave socket 510. When the system 100 is operated, the eversible structure will grow and, because of abutment against the solid structure, force the chamber 130 and pump 120 forward 610 through the borehole. To help aid translation through the borehole 105, the chamber 130 and pump 120 are provided with outwardly-facing rollers 620 for rolling against the inner wall of the borehole. In this way, the entire system is simultaneously transportable through the borehole 105 whilst lining the borehole, thereby allowing the system 100 to be re-located for use at another borehole proximate a terminus of the borehole 105.

The principles of the examples shown in, and described with reference to, FIGS. 5 and 6 are available to be combined, such that the drill 500 is pushed by the entire system 100 moving as a result of constrained apical growth of the distally-located eversible structure 115, rather than directly by the adjacent eversible structure (as in the example of FIG. 5).

Each feature disclosed herein, and (where appropriate) as part of the claims and drawings may be provided independently or in any appropriate combination.

Any reference numerals appearing in the claims are for illustration only and shall not limit the scope of the claims.

1. An apparatus for lining for a borehole, said apparatus comprising a/an:
eversible structure configured to be everted into a distended structure defining a lumen and to grow apically;
cavity provided within the eversible structure and arranged to surround the lumen;
curable material, provided within the cavity, for setting into a solid under a curing action, thereby to form a solid structure; and
non-excavating drill, wherein the drill is arranged to be urged by apical growth of the eversible structure.

2. An apparatus according to claim 1, wherein the eversible structure is formed of a double-walled membrane, and wherein the cavity is defined by the double-walled membrane.

3. An apparatus according to claim 1, wherein the cavity is entirely enclosed by the eversible structure, thereby sealing the curable material within the eversible structure.

4. An apparatus according to claim 1, wherein the eversible structure further comprises an opening arranged at a terminal end of the eversible structure, for receiving a fluid for forcing eversion of the eversible structure.

5. An apparatus according to claim 1, wherein the eversible structure comprises a valve for connecting the lumen with an exterior of the eversible structure, said valve being configured to permit escape of fluid from the lumen.

6. An apparatus according to claim 1, wherein the eversible structure is formed into a coil.

7. An apparatus according to claim 6, further comprising a spool or a drum, and wherein the eversible structure is coiled about said spool or drum.

8. An apparatus according to claim 1, wherein the eversible structure is dimensioned to be received within a borehole when formed into the distended structure

9. An apparatus according to claim 1, wherein the curable material comprises a curable resin.

10. An apparatus according to claim 1, wherein the curing action is: heating; light exposure; and/or exposure to a curing additive.

11. An apparatus according to claim 1, further comprising a curing apparatus for causing the curing action.

12. A system for forming a supporting lining for a borehole, said system comprising:
an apparatus comprising a/an:
eversible structure configured to be everted into a distended structure defining a lumen and to grow apically;
cavity provided within the eversible structure and arranged to surround the lumen;
curable material, provided within the cavity, for setting into a solid under a curing action, thereby to form a solid structure; and
non-excavating drill, wherein the drill is arranged to be urged by apical growth of the eversible structure;
a pump for pumping a fluid at the eversible structure so as to cause eversion and apical growth of the eversible structure; and
a curing apparatus for causing the curing action thereby to set the curable material into a solid.

13. A system according to claim 12, further comprising a sealed pressure vessel containing the pump and the apparatus, wherein the sealed pressure vessel comprises an engagement formation for engaging the apparatus, and wherein the eversible structure is configured to evert and apically grow away from the pressure vessel under pressure from within the pressure vessel.

14. A method of operating a system for lining a borehole, wherein the method comprises the steps of:
fixing an everted end of an apparatus according to claim 1;
operating a pump so as to pump a fluid at the eversible structure thereby to force eversion and apical growth of the eversible structure away from the everted end, thereby to form the distended structure; and
performing a curing action, using a curing apparatus, thereby to set the curable material and the eversible structure into the solid structure.

15. A method according to claim 14, wherein the curing action is performed whilst also operating the pump so as to pump a fluid at the eversible structure.
